(19) United States
(12) Patent Application Publication
(10) Pub. No.: US 2022/0043180 A1
(43) Pub. Date: Feb. 10, 2022

(54) METHOD AND SYSTEM OF REAL-TIME SIMULATION AND FORECASTING IN A FULLY-INTEGRATED HYDROLOGIC ENVIRONMENT

(71) Applicant: Aquanty Inc., Waterloo (CA)

(72) Inventors: Steven K. FREY, Waterloo (CA); Graham STONEBRIDGE, Waterloo (CA); Steven J. BERG, Waterloo (CA); Edward A. SUDICKY, Waterloo (CA)

(21) Appl. No.: 17/280,769

(22) PCT Filed: Sep. 30, 2019
(86) PCT No.: PCT/CA2019/051398

§ 371 Date: Mar. 26, 2021

Related U.S. Application Data
(60) Provisional application No. 62/738,001, filed on Sep. 28, 2018.

(51) Int. Cl. G01V 9/02; G06N 7/00; G01W 1/14

(52) U.S. Cl. CPC G01V 9/02; G01W 1/14; G06N 7/00

(57) ABSTRACT

The system and method for generating a forecast or simulation in a hydrologic environment includes the comparison of real-world observations with archived model states to generate or obtain initial conditions for the generation of the forecast or simulation. By using archived model states to generate forecast initial conditions, a more realistic simulation may be generated. The output of the simulation may then be stored as new model states with the other archived model states to maintain an updated archive of model states.

### CROSS-REFERENCE TO OTHER APPLICATIONS

This application claims priority from U.S. Provisional Application No. 62/738,001 filed Sep. 28, 2018, the contents of which are hereby incorporated by reference.

### FIELD

The disclosure is generally directed at hydrology and hydrogeology, and more specifically, at a method and system of real-time simulation and forecasting in a fully-integrated hydrologic, such as a surface water and groundwater, environment.

### BACKGROUND

Traditionally, integrated hydrologic models have been developed to answer a specific question such as, what happens to the surrounding landscape if a mine is built in a certain location or what are the effects of climate change on a watershed? Once complete, the results are published and the model may not be used again for years.

Current technical complexities preclude the robust deployment of fully-integrated hydrologic simulators as forecasting tools that incorporate near real-time terrestrial sensor-based information and/or remote/satellite-sensing data within a data assimilation framework. Data assimilation is an important component of a forecasting platform as it brings the simulation-state to a condition that best matches the real-world state. Hydrologic forecasting has thus far only utilized relatively simple simulation tools (i.e. surface water only or groundwater only models) to generate forecasts. These simple tools are known to be robust and numerically efficient due to their specific focus on a single component of the hydrologic system (i.e. surface water or groundwater). Due to the relatively linear mathematics associated with a single component simulator, they can utilize a well-known data assimilation methodology such as the Ensemble Kalman Filter. While suitable for single component forecasting, current solutions do not holistically capture the dynamic movement of water between the soil, surface water, and groundwater components of the terrestrial water cycle, and, as such, are limited in their applicability in the sense that they only produce forecasts specific to either surface water or groundwater conditions.

In the current disclosure, there is provided a method and system of real-time simulation in a fully-integrated surface water hydrology and groundwater environment that overcomes at least one disadvantage of current systems.

### SUMMARY

The disclosure is directed at a system and method for near real-time hydrologic forecasting. In one embodiment, the disclosure may drive basin scale hydrogeology models with a two-week probabilistic weather forecast which provides stakeholders with probabilistic forecasts of more than one condition. For instance, streamflows, soil saturations, and groundwater levels for the entire watershed may be forecast in a single model. The disclosure may further be seen as disclosing a methodology for utilizing fully-integrated surface water and groundwater simulation tools within a hydrologic forecasting platform. The system and method of the disclosure moves away from ‘one-off’ simulations to near real-time hydrologic simulation and forecasting.

One aspect of the disclosure is the determination of the appropriate initial condition for the integrated hydrologic model that best matches field observations (this is called data assimilation). The method of the disclosure includes a novel assimilation method designed specifically for integrated hydrologic models. The method of the disclosure, which may be seen as an ensemble variational data assimilation with a library state selector, is both efficient and robust. In an embodiment, the disclosure yields initial model states that may be conditioned to run quickly thus allowing real-time forecasting that was not previously available. For instance, in one embodiment, the system and/or method of the disclosure may provide flood and drought forecasting.

In another aspect of the disclosure, there is provided a method of real-time simulation and forecasting in a fully-integrated hydrologic environment including receiving a set of input field data; determining a set of real-world observations based on the set of input field data; and determining a set of forecast initial conditions based on the set of real-world observations and a library of archived model states.

In another aspect, determining the set of forecast initial conditions includes comparing the set of real-world observations with the archived model states; and selecting the model state or model states that best match with the set of real-world observations. In a further aspect, selecting the model state or model states includes performing an optimization approach on between the archived model states against the real-world observations. In yet another aspect, selecting the model state or model states further includes evaluating the archived model states against the real-world observations using a user-defined objective function or user-defined loss function. In another aspect, the method further includes generating raw forecast data based on the forecast initial conditions. In yet another aspect, the method further includes storing the raw forecast data in the library of archived model states. In an aspect, the method further includes generating a forecast and/or simulation based on the raw forecast data. In another aspect, the method further includes displaying the forecast and/or simulation. In yet a further aspect, the method includes comparing the raw forecast data with the selected model states to determine if there is variability and/or range between the raw forecast data and the selected model states; and updating the library or archived model states to include the raw forecast data if variability and/or range is determined.

In another aspect, the method further includes receiving a set of weather forecast data; and processing the set of forecast initial conditions and the set of weather forecast data to generate the raw forecast data. In yet a further aspect, the set of weather forecast data includes a set of precipitation data; and a set of potential evapotranspiration data.

In another aspect of the disclosure, there is provided a system for generating a real-time simulation and forecast in a fully-integrated hydrologic environment including an initial conditions assimilator for receiving a set of input field data and a set of archived model states and comparing the set of input field data and the set of archived model states to determine which of the set of archived model states best match the set of input field data, wherein the determined set of archived model states represents forecast initial conditions; and a simulation component for generating raw forecast data based on the forecast initial conditions and a set of weather input data.

In an aspect, the system further includes a weather processing component for separating the set of weather input data into precipitation data and potential evapotranspiration. In another aspect, the system further includes a database storing the set of archived model states.

In another aspect of the disclosure, there is provided a computer readable medium having stored thereon instructions that, when executed, cause a processor to receive a set of input field data; determine a set of real-world observations based on the set of input field data; and determine a set of forecast initial conditions based on the set of real-world observations and a library of archived model states.

### DESCRIPTION OF THE DRAWINGS

Embodiments of the present disclosure will now be described, by way of example only, with reference to the attached Figures.

FIG. 1 is a conceptual diagram of a system for real-time forecasting;

FIG. 2 is a schematic diagram of a process flow chart embodying a real-time forecasting system;

FIG. 3 is a schematic drawing of physical processes represented by a groundwater—surface water model;

FIG. 4 is a flowchart outlining a method of real-time forecasting;

FIG. 5a is a schematic diagram of an initial conditions assimilation process:

FIG. 5b is a flowchart outlining a method of determining forecast initial conditions; and

FIG. 5c is a flowchart outlining a method of storing raw forecast data.

### DETAILED DESCRIPTION

The disclosure is directed at a method and system for real-time simulation for a fully-integrated surface water hydrology and groundwater model. In one embodiment, the system (which in one example may be a simulation component such as a simulator, simulation engine or simulation module) of the disclosure receives and processes field sensor data and combines it with weather forecasts or weather forecast data to generate prediction models or forecasts including at least two of surface water, groundwater and soil moisture conditions. In one embodiment, the system of the disclosure may be seen as a computation and simulation engine for generating a fully-integrated soil moisture, surface water and groundwater forecasting model.

In another embodiment, the method of the disclosure provides a method for data assimilation to determine forecast initial conditions for use in generating the forecast and/or simulation. In one embodiment of the method, terrestrial sensor data describing or representing at least two of soil moisture, surface water, and groundwater conditions (preferably in near real-time) may be assimilated into a fully-integrated hydrologic simulation system in a robust and numerically efficient process.

One advantage of the current disclosure is that it may handle the inherent non-linearity and numerical instability associated with initializing a simulator, wherein at least two of the soil moisture, surface water, and groundwater components of the simulator are prescribed at least one forecast-starting-condition that lies within an initial condition indexing and selection method. In another embodiment, the system of the disclosure described herein may generate near real-time hydrologic forecasts or models at spatial scales ranging from small agricultural fields (<1 km²) to large river basins (>150,000 km²). The system of the disclosure may also use a wide selection of deterministic (i.e. a single forecast) or ensemble (i.e. multiple forecasts) weather forecast data of various spatial and temporal resolutions and of various forecast time intervals to generate the model. Multiple forecasts may be used to facilitate statistical analysis of probability and uncertainty.

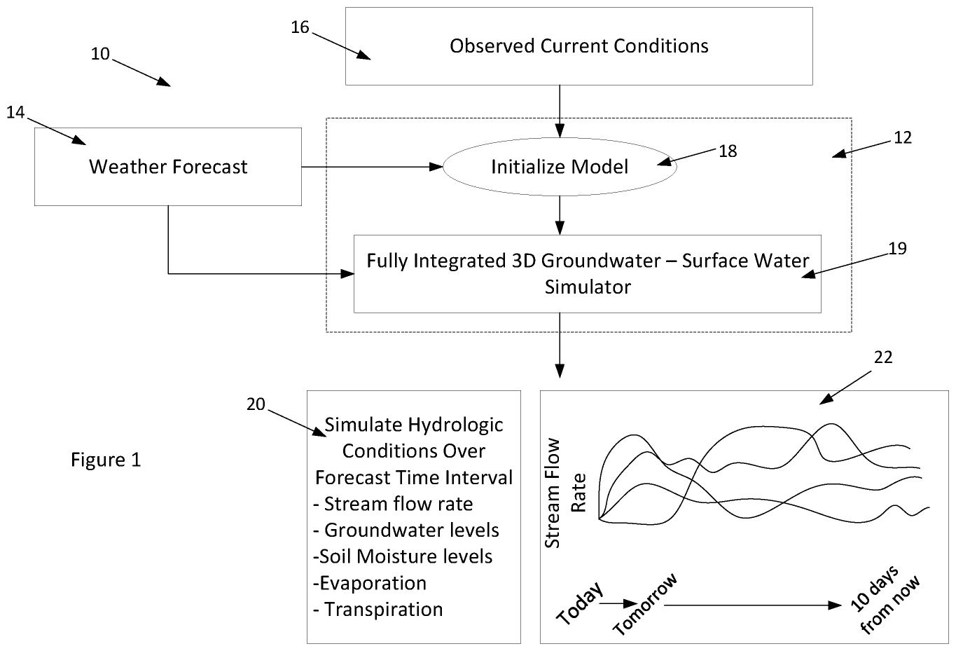

Turning to FIG. 1, a conceptual overview of a system for real-time simulation and forecasting is shown. In the current figure, the system 10 includes a fully-integrated hydrologic forecasting platform 12 that generates forecasting data or raw forecast data, on which the real-time simulation and forecasting, or forecasting, is based. The raw forecast data is generated via the processing of input data from different sources which may be integrated with or separate from the forecasting platform 12. Examples of input data include, but are not limited to, weather forecast input 14 and observations of current conditions input 16. The weather forecast input 14 may be received from a server that stores weather information or a system that provides weather information on a continuous basis. The observations of current conditions input 16 may be associated with the landform or landscape environment for which the forecasting model is being generated. For instance, examples of observed conditions, or variables, input 16 include, but are not limited to, terrestrial soil moisture, surface water and groundwater data watershed conditions and/or remote sensing/satellite data.

The system 10 may further include an initialization processor or module 18 that modifies the observations of current conditions input 16 so that the input data may be processed by the platform 12 such as via a fully integrated three-dimensional (3D) groundwater—surface water simulator, or simulation component, 19. This initialization processor 18 may execute a data assimilation procedure involving the selection of a best-fitting model state from a library of prior model states, as will be discussed below. After receiving and processing the input data, the platform 12 generates raw forecast data and/or a model or forecast showing hydrologic conditions over a forecast time interval for the landform of interest.

As can be seen in FIG. 1, input data (such as in the form of the weather forecast input 14 and/or observations of current conditions input 16) is received by the system 12. The observational data input 16 may then be pre-processed by the initialization processor 18 to produce input for the simulation component 19. The observations of current conditions input 16 and the weather forecast input data 14 are then processed by the platform 12 to produce raw forecast data to assist in the generation of a fully-integrated surface water hydrology and groundwater hydrogeology forecast 20. In another embodiment, the platform 12 may also generate the fully-integrated surface water hydrology and groundwater hydrogeology forecast 20.

In the current embodiment, the system 10 may be seen as a fully integrated three-dimensional (3D) groundwater—surface water forecasting system. In another embodiment, the fully-integrated model generated by the platform 12 simulates or forecasts, surface water and groundwater conditions over the forecast time interval. Along with the generated model, the system 10 may also generate a stream flow rate graph 22 based on the forecast time interval. As shown in the graph 22 of FIG. 1, the forecast time interval for the current example is 10 days calculated from the present date to a date 10 days from the present date. As will be understood, the forecast time interval may be set for whatever time range that is requested or required.

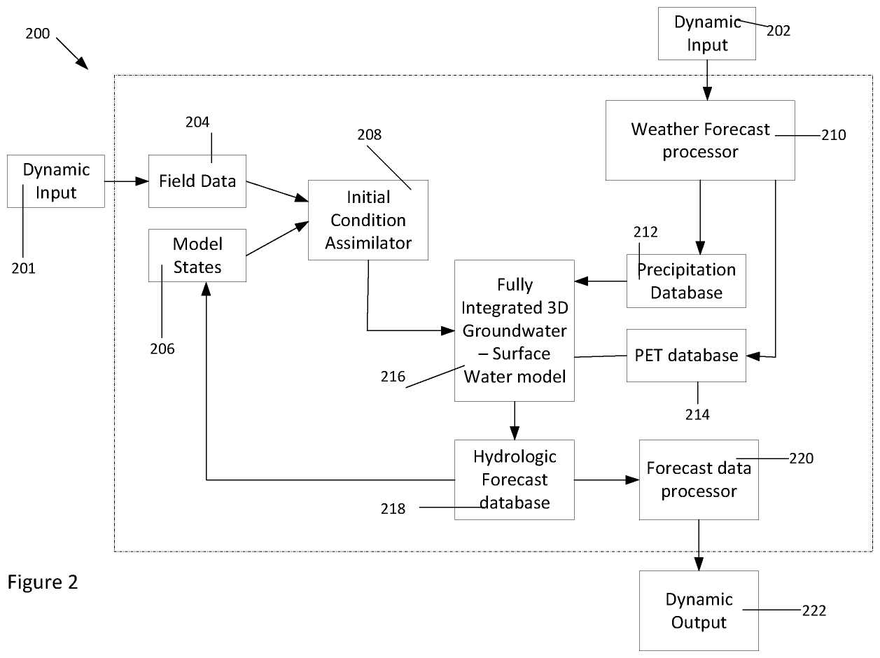

Turning to FIG. 2, a schematic diagram of a flow chart integrated with respect to the system of the disclosure is provided. Based on received inputs, the system 200 generates raw forecast data and/or a forecast that can then be output for visualization and dissemination.

Initially, the system 200 receives a first dynamic input 201. This first dynamic input 201 may be seen as field or raw data 204 that has been collected out in the “field”. As they are from the “field, they may also be seen as observed current conditions. In one embodiment, the first dynamic input 201 is received by the system via the transmission of application programming interface (API) calls to external data providers such as, but not limited to, an external web-based time series database, or an external satellite imagery database. The data may also be input to the system manually by a user or transmitted by sensors retrieving real-world data. In one embodiment, the field data 204 may be terrestrial and/or remotely sensed real-world state data. In other words, the field data may be seen as a representation or estimate of real-world conditions of the landscape or landform for which the forecast and/or simulation is being generated.

The field data 204 is combined or assimilated with prior (archived) real-world state estimates such as, but not limited to, model states that have been previously generated by the hydrological model component 216 that are stored in a model state library 206. These archived model states may also be seen as data that can be used as initial conditions for a forecast. One example of a model state may be watershed conditions. Watershed conditions may be seen as information associated with, but not limited to, groundwater head and surface water (SW) flow rates. The model state library 206 may further store other landscape or landform data or information about the area for which the simulation or forecast is being generated. The output or combination of the field data 204 and the data in the library of model states 206 are transmitted to an initial condition assimilator 208 that generates a new model state, which may be considered the forecast initial conditions, for use by a fully integrated 3D Groundwater—Surface Water model or simulator 216. The initial condition assimilator 208 may be seen as a data-miner that evaluates the prior model states, or candidate model states, that are stored in the model state library with respect to the field data 204 to determine the model state or states that are most representative of real-world conditions, the observed current conditions or field data 204. These determined model states are then used as initial conditions for the forecast and/or simulation. These may be seen as the forecast initial conditions. These determined model states may also be seen as a new model state or new set of model states. This will be discussed in more detail below.

The data generated or determined by the initial condition assimilator 208 is then transmitted or passed as a forecast initial conditions or forecast initial conditions data to the fully integrated 3D groundwater and surface water simulator 216.

A second dynamic input 202 is received by the system 200 concurrent to the receipt of the first dynamic input 201. Alternatively, the first and second dynamic inputs 201 and 202 may be received in a predetermined order or whenever the information is available. The second dynamic input 202 may include weather forecast data (ensemble or deterministic).

The weather forecast data is processed by a weather forecast processor 210 to transform or separate the second dynamic input into precipitation data (that is stored in a precipitation database 212) and potential evapotranspiration (PET) data (that is stored in a PET database 214). The precipitation data and the PET data are both transmitted to the fully integrated 3D groundwater—surface water simulator 216 as atmospheric forcing data to serve as at least one atmospheric boundary condition for the forecast or model that is being generated. Subsequent to receiving the atmospheric forcing data and establishment of the initial model states or forecast initial conditions, a fully integrated hydrologic model simulation can be executed by the simulation component 216, thereby generating raw forecast output.

An output of the simulation component 216, preferably in the form of raw forecast data, is stored in a hydrologic forecast output database 218. The raw forecast data may include surface water flow rates, groundwater heads and levels, soil moisture, and evapotranspiration data and the like. The raw forecast data may also include the data and/or information necessary to generate a simulation model for display to a user.

This raw forecast data is then processed (or post-processed) by a forecast evaluation or data processor 220 for use in forecast evaluation and analysis. The post-processed forecast raw data may also be transmitted to the forecast evaluation or data processor 220 for geospatial visualization and/or statistical analysis and then displayed as a dynamic output 222 to a user. An output of the hydrologic forecast module (such as the raw forecast data) may also be transmitted to the model state library 206 for archival and for use in the next simulation as part of a feedback loop. By storing the raw forecast data back into the model state library as a new model state, the new model state may then be used as an initial condition for a future forecast. In this manner, a model state library having near real-time estimates of real-world conditions may be maintained. In an alternative embodiment, the raw forecast data may be compared with previously stored model states to determine if any of the previously stored model states should be replaced with the raw forecast data. In another embodiment, the raw forecast data may be stored in the model state library along with other model states without deleting other model states.

In one specific embodiment of operation, prior to initializing a forecast simulation, observations of the current real-world situations may be obtained in order improve the forecast. These observations of real-world states may represent a set of estimates or samples of real-world conditions. These observations are then used to improve the selection of forecast initial conditions. In order to obtain near-real-time observations (or samples), real-time or near real-time field sensor and remotely sensed data that may quantitatively describe at least one of stream/river flow, groundwater levels, soil moisture levels, and snow cover information (i.e. snow pack snow water equivalent and/or snow depth) is obtained or received. This information can be seen as the first dynamic input 201 or the field data 204. In one embodiment, this information may be accessed via API calls that provide the connection between the system 200 and real-time data feeds.

As will be understood, both the first and second dynamics inputs 201 and 202 may be received from any number of data feeds. If no real-time or near real-time data feeds are available, the system may operate in an open-loop status with no feedback from real-world observations. In one embodiment, the input data 201 and 202 may be point-based (such as from terrestrial stream flow gauges and groundwater gauges) or spatially distributed (such as received by remote sensors).

In one embodiment, the first dynamic input 201 may be observational data or certain current real-world data including, but not limited to, terrestrial stream flow data, terrestrial groundwater levels data, terrestrial soil moisture data, terrestrial snow depth and density data, remote sensing soil moisture data, remote sensing surface water extent data and modelled/remotely sensed snow data.

The terrestrial stream flow data may be obtained from terrestrial stream flow gauges that provide ground-based sensor data describing flow rates in rivers and streams. This real-time flow data may be available or retrieved from government agencies. Online databases may also be used to obtain the terrestrial stream flow data. For Canada, the information may be obtained from the website: https://wateroffice.ec.gc.ca/mainmenu/real_time_data_index_e.html, for the United States, the website is: https://waterdata.usgs.gov/nwis/rt; and for the United Kingdom, the website is: http://environment.data.gov.uk/flood-monitoring/doc/reference. Privately operated gauges can also be a source of real-time stream flow data.

For the terrestrial groundwater levels data, the information may be received from terrestrial groundwater level (or pressure head) gauges that provide ground-based sensor data describing water table elevation or subsurface water pressures in subsurface wells. As with the terrestrial stream flow data, real-time groundwater level data may be obtained from websites associated with government agencies, such as in Canada (Ontario Provincial Groundwater Monitoring Network) and the United States (https://groundwaterwatch.usgs.gov/net/ogwnetwork.asp?ncd=rtn). Privately operated gauges can also be a source of real-time groundwater level data.

For terrestrial soil moisture data, this information may be received from terrestrial soil moisture monitoring sensors that provide ground-based data describing how much water is being held in the soil profile. For terrestrial snow depth and density data, this information may be received from terrestrial snow depth and density gauges that provide information on how much water is being held in the snow pack (snow water equivalent).

For remote sensing soil moisture data, this information may be received from satellite remote sensing that provides near real-time spatially distributed data describing soil moisture levels in the shallow subsurface. An example remote sensing soil moisture data product is the Soil Moisture Active Passive (SMAP) dataset that is available from the National Aeronautics and Space Administration (NASA) and/or the Soil Moisture and Ocean Salinity (SMOS) product from the European Space Agency (ESA).

For the remote sensing surface water extent data, this information may be received from satellite remote sensors that provide data that can be used to calculate surface water extent in near real-time, such as optical imagery from NASA's Landsat and ESA's Sentinel-2, as well as synthetic aperture radar (SAR) data feeds. For modelled and/or remotely sensed snow data, this information may be received in near real-time for much of North America via the National Oceanic and Atmospheric Administration (NOAA) Snow data Assimilation System (SNODAS) system. The information may also be received from NASA's LANCE system that provides satellite remote sensing-based snow water equivalent data in near real-time.

In another embodiment, the second dynamic input 202 may be seen as weather forecast inputs or input data. The meteorological forcing data that provides atmospheric boundary condition for the system is preferably obtained from processing the weather forecast inputs. The weather forecast inputs can be either deterministic (i.e. a single weather forecast) or ensemble based (i.e. multiple weather forecasts). With either type, the forecast inputs preferably include quantitative estimates for precipitation and air temperature. Additional information such as wind speed, humidity, and solar radiation may also be included in the weather forecast inputs as they facilitate detailed calculation of potential evapotranspiration rates within the forecasting platform. It will be understood that these are not absolutely required because basic potential evapotranspiration rates can also be calculated based on precipitation and air temperature data.

As discussed above, the weather forecast inputs may be deterministic or ensemble based. For a deterministic weather forecast, this may be seen as a single realization of weather over the simulation domain (or landscape of interest) for the time frame of interest or forecast time interval. The deterministic forecast may include uniform or spatially varying climate indices such as, but not limited to, precipitation and air temperature. A deterministic weather forecast does not facilitate a statistical analysis of weather forecast induced uncertainty within the hydrologic forecasting platform.

For an ensemble weather forecast, this may be seen as multiple realizations of weather over the simulation domain (or landscape of interest) for the time frame of interest. The ensemble forecast may also include uniform or spatially varying climate indices such as precipitation and air temperature. An ensemble weather forecast facilitates a statistical analysis of weather forecast induced uncertainty within the forecasting platform or system, in that multiple hydrologic simulations can be conducted (each forced with a different weather forecast) and the variability can be assessed.

The second set of dynamic inputs 202 may also be conditioned by the system. Prior to use of the weather forecasting data by the simulation component, the raw weather forecast data may be conditioned. In one embodiment, the data is conditioned by aligning the geographical co-ordinate system with that of the model. The alignment may include unit conversion and data pre-processing to account for snow accumulation and melting and to calculate a potential of the atmosphere to draw water out of the terrestrial hydrologic system via evapotranspiration processes. Examples of the data pre-processing include determining or generating information relating to precipitation and potential evapotranspiration.

For precipitation, prior to being directly used in the hydrologic simulator or model 216, the measurement units and geographical coordinate system of the precipitation data are checked and if need be, converted to the units and coordinate system of the simulator 216. If the precipitation data represents total precipitation (i.e. rainfall+snowfall) then air temperature may need to be taken into account, and if air temperature is below freezing, snowfall may need to be accounted for by accumulating the spatial distribution of snow (SWE—snow water equivalent) in a numerical SWE reservoir. If some positive value of SWE exists in the reservoir, then air temperature may also need to be considered within the context of snowmelt, as snow will need to be melted and subsequently added to the liquid water component of the hydrologic simulator forcing data. The total amount as well as rate of snowmelt can be calculated using a simple degree-day method, or with more complex energy balance based methods, depending on the available weather information.

Potential evapotranspiration (PET) data is a common requirement of a fully-integrated groundwater—surface water simulator and is a quantitative value or data that defines the rate at which the atmosphere can draw water from the land surface via evaporation and plant transpiration processes. PET can be calculated from the precipitation and air temperature data using the Priestley-Taylor method, or the Penman-Monteith method, depending on the available weather information. Like precipitation data, PET data conditioning needs to adhere to the measurement units and geographical coordinate system of the forecasting platform 216.

In operation, the fully integrated groundwater-surface water simulator 216 generates or produces the actual hydrologic forecasts or the raw forecast data for use in generating a model that can be displayed to a user. In one embodiment, the pre-conditioned weather forecast data (either deterministic or ensemble) is transmitted to or received by the simulator or model 216, which then proceeds to simulate the transient response of the groundwater, surface water, and soil moisture system over the simulation time frame or time frame of interest for the area or domain of interest.

In the case of a deterministic weather forecast, either a single hydrologic simulation or an ensemble of simulations that are each forced with the same weather data but each having a different initial starting condition is/are executed. In the case of an ensemble weather forecast, multiple hydrologic simulations are executed in order to represent the different combinations of weather forecasts and initial starting conditions that are of interest. Once executed, the hydrologic simulator forecasts at least two of the groundwater, surface water, soil moisture, and evapotranspiration responses to the weather forcing data. When an ensemble of simulations is executed, the output from the integrated hydrologic simulator can be assessed with statistical metrics (i.e. probability of exceedance, mean, median, variance, uncertainty etc.). In the fully-integrated groundwater—surface water simulator, water flow through the groundwater system, soil profile, and rivers/streams is intrinsically linked, meaning that water can seamlessly move within the components of the hydrologic system.

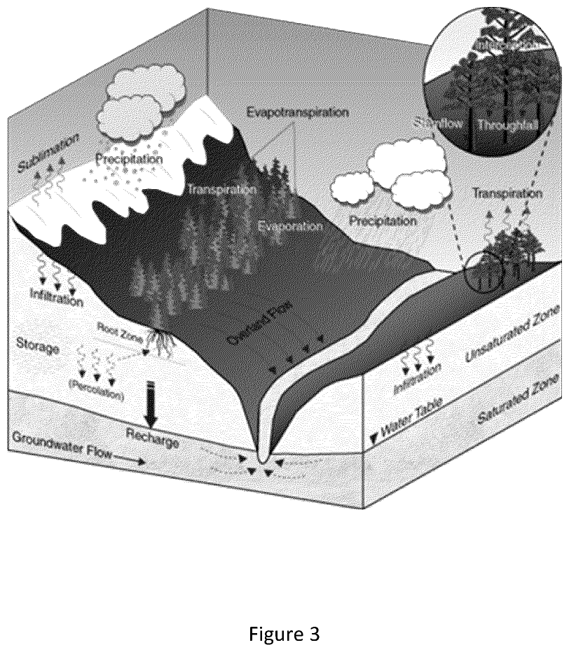

The platform includes a groundwater system module which, in the fully-integrated groundwater—surface water simulator, resolves the movement of water (such as schematically shown in FIG. 3) through the subsurface (including aquifers and aquitards) in three dimensions, and can simulate the dynamic exchange of water between the river/stream network and the soil. The surface water system module, in the fully-integrated groundwater—surface water simulator module 216, resolves the movement of water through river and stream channels as well as over the off-channel land surface (such as during floods). The surface water system can simulate the dynamic exchange of water between the groundwater system and the soil system. The soil system module in the fully-integrated groundwater—surface water simulator resolves the movement of water within the soil in either one- or three-dimensions. Within the soil system, plant influences on water movement (i.e. root uptake and transpiration) as well as evaporation can be considered.

The assimilation and model state-space initialization (by the initial conditions assimilator 208) involves assessing the near real-time dynamic input coming from the field sensors and remote sensing data feeds and then initializing the model state-space to best reflect the current state of the real world. Either a single model state or an ensemble of model states can be established via weighted optimization, such that the hydrologic forecast simulation begins from a single (or set of) condition(s) that reflects the relative importance of the current surface water, groundwater, and soil moisture state. Because the relationship between groundwater, surface water, and soil moisture is highly nonlinear in a fully-integrated hydrologic simulator, traditional data assimilation methodologies (i.e. Ensemble Kalman Filter) can yield initial model states that are numerically unstable, and hence can create a situation where the hydrologic forecast simulation either fails to converge or converges very slowly. Such uncertainty with the numerical solution precludes hydrologic forecast production within a dependable time frame, and as such, can limit the utility of fully-integrated hydrologic simulators within forecasting applications.

To overcome this limitation, a new data assimilation and model state initialization method and system is disclosed, wherein a library of model states 206 is established a priori. The usage of a model state library over other published data assimilation methods is based on an observed principle that the current state of the real world is often similar to its state at some point in history, or at some point as predicted within a hydrologic forecast simulation. If this (these) states can be identified, a logical initial state for simulating the current forecast can be determined. In one embodiment, data mining combined with weighted-spatial and -component (groundwater, surface water, and soil moisture) optimization may be employed to select the model state(s) that become the initial condition(s) for a hydrologic forecast simulation from the library. As the state vectors in model state library represent numerically stable combinations of groundwater, surface water, and soil moisture conditions, generation of the hydrologic forecast simulations may proceed from the outset unencumbered by convergence problems with the numerical solution; which leads to predictable simulation time (i.e. time required to simulate future hydrologic conditions) and efficient use of computing resources. This novel data assimilation and model state-space initialization is robust and facilitates the use of fully-integrated hydrologic simulators in large scale forecast applications. The assigned spatial and component optimization weights can be aligned to the primary objectives of the hydrologic forecasting platform (i.e. a hydrologic forecasting platform primarily intended for flood forecasting could employ higher weights to the surface water component).

The system further includes the hydrologic forecast database 218 and the forecast data processor 220. Once the field sensor and remote sensing data has been processed by the initial condition assimilator 208 and the model state-space has been initialized and the weather forecast has been conditioned for use with the fully-integrated hydrologic simulator 216, production or generation of the hydrologic forecast (or raw forecast data) can commence and the raw forecast data can then be stored in the hydrologic forecast database 218.

In one embodiment, generation of the hydrologic forecast includes executing or running a fully-integrated hydrologic simulation for each required combination of weather forecast scenario and initial model state. When a deterministic weather forecast is used with a single optimized model state-space, a single simulation is generated; however, if an ensemble of weather forecasts is required, and/or an ensemble of initial conditions is required, then multiple simulations will be required (i.e. if 10 weather forecasts are combined with an ensemble of three initial conditions then up to 30 simulations would be required). Whether it is one or multiple simulations required for the hydrologic forecast production, the simulations can be executed on local and/or cloud computing (i.e. AWS, Azure etc.) resources, with the required computing resource time allocation being directly comparable to the length of time required to execute the simulation(s) from start to finish. Alternatively, the forecast production can be constrained by time, meaning that if new hydrologic forecasts are required at a specific frequency, then the forecast platform can stop the simulations while in-process and proceed to process the simulation output.

Another component of the system is the forecast data processor 220. As part of the fully-integrated hydrologic forecasting platform, the forecast data processor may include an evaluation module that performs an automated assessment of the forecast skill. Assessing the forecast skill entails conducting a hindsight analysis of the match between forecasted and experienced hydrologic conditions. The hindsight analysis can be conducted for any time-increment within the total forecast length (i.e. a three-day forecast skill assessment would compare the forecast produced three days ago to the real-world conditions observed today). There are many metrics upon which the skill evaluation can be based, including, but not limited to, bias (i.e. whether the simulations overpredict or underpredict hydrologic conditions), statistical correlations between simulated and observed hydrologic conditions, and threshold analysis (i.e. how well the simulations capture the response to hydrologic events of different magnitudes). When only a deterministic hydrologic forecast has been produced, direct evaluation of the forecast data can be conducted; whereas if an ensemble forecast has been produced, different statistical representations of the forecast data can be evaluated (i.e. mean, median, quartiles, etc.). Additionally, if observed meteorological data is available for a single (or multiple) location(s) within the area for which the hydrologic forecast is being produced, a similar assessment of skill can be produced for the weather forecast; subsequent to which, a comparison can be made between hydrologic forecast skill and weather forecast skill.

The model state library 206, hosts or stores preconfigured sets of numerically stable model state-space descriptions that can be drawn from when initializing the fully-integrated groundwater—surface water simulator 216. Since these state-space descriptions are numerically stable, they facilitate a robust launch of a hydrologic forecast simulation without the traditional simulation spin-up period that is required after data assimilation in order to numerically equilibrate the model state-space across the groundwater, surface water, and soil moisture components of the fully-integrated hydrologic simulator. The model state library can be either static, such that it is pre-assembled during construction of the forecasting platform, or dynamic, such that the set of model states can be added-to and/or subtracted-from on an ongoing near real-time basis.

Because the model states extracted from historic simulations are proven (or can be verified) for their numerical stability, they serve as a robust starting point for any new simulation. Potentially, thousands (or more) model states can be saved in the model state library 206 for potential use in hydrologic forecast simulations.

In the disclosure, if the model state library is a preconfigured fixed library or static library, all of the model states are pre-assembled into the library 206 and then the library is loaded into the platform or system. The initial conditions for the static library can be extracted from historic fully-integrated hydrologic simulations (historic reanalysis), where for example, during each day within the historic simulation the model states are extracted and saved. Upon completion of the historic simulation all of the saved states can be assessed for total and inter-component (e.g. groundwater, surface water, and soil moisture) variability, where an optimal or preferred number of model states providing an optimal or preferred range of conditions and loaded back into the model state library for a future simulation. With the static model state library, new model states can be added subsequent to the first assembly of the library. Currently, any additions or updates are made off-line and then the updated model state library is loaded into the hydrologic forecasting platform.

With an evolving model state library 206, or dynamic library, the dynamic model state library is similar to the static model state library in that an initial library is assembled prior to the launch of the forecasting platform or system, and in that the model state library contains an optimal or preferred number of model states that represent an optimal or preferred range of state-space conditions. However, unlike the static model state library, the dynamic model state library can be updated in near real-time, meaning that if during the generation of a fully-integrated hydrologic forecast, a model state is or was observed to be significantly different from the existing model states within the current initial conditions library, then the new model state could be added to the library while the platform is operational such that the new state may be used as an initial starting condition for a future simulation. Similarly, as new model states are added to the model state library, the variability within the model state library can be regularly evaluated, and individual model states may be removed if they are deemed to no longer be necessary. The dynamic model state library provides the advantage of being able to evolve in order to accommodate hydrologic conditions within the forecast domain that have not been experienced over the simulation time frame upon which the static model state library was established. For example, if a recent extreme weather event is creating conditions within the forecast domain that have not previously been experienced, a model state extracted from the forecast from the previous day would provide a better initial condition than any state derived from a historic reanalysis simulation.

The output, or raw forecast, data produced or generated by the fully integrated hydrologic simulator 216 can include temporally varying information on hydrologic variables at discrete points in space (i.e. stream/river flow data, soil moisture level data, groundwater level or head data, evapotranspiration data, and snow pack data) which can be visualized in time series format (i.e. ascii or csv). Additionally, the simulator, or system, can produce temporally and spatially varying information for the same aforementioned variables (except stream/river flow data) that can be visualized in a time varying geospatial format (i.e. raster-type data in formats such as ascii, geotiff, NetCDF etc.). When a single deterministic forecast is produced, only a single set of simulator outputs exists for each variable, which precludes statistical analysis. When an ensemble-based forecast is produced, a set of outputs exists for each ensemble member. Ensemble forecast production facilitates statistical analysis of the forecast output, including, but not limited to, metrics such as mean, median, variance, quantile, as well as various measures of uncertainty. In the case that an ensemble of hydrological forecasts is generated from an ensemble of weather forecasts, but using only one hydrological initial condition, then the statistical and uncertainty analysis pertains only to the influence of weather forecast variability on the forecasted hydrologic conditions. Alternatively, in the case that an ensemble of hydrological forecasts is generated from a single deterministic weather forecast, but with separate initial conditions for each hydrological forecast member, then the statistical and uncertainty analysis will pertain to the influence of the initial conditions utilized for the fully-integrated hydrologic simulator. If the ensemble is composed of both ensemble weather forecast and varied initial condition data, then the statistical and uncertainty analysis can be conducted for a set of ensemble data (weather forecast and initial condition data) independently or combined.

The raw forecast data may include information relating to any number of different forecasts, including, but not limited to, a stream/river flow forecast, a groundwater levels forecast, a soil moisture levels forecast; an evapotranspiration forecast and/or a snow pack forecast or models that can be displayed to a user or analyst.

The stream/river flow forecast represents surface water flow rates (or depths) for discrete points within the surface water network in the fully-integrated hydrologic simulator. The points can represent locations where either an actual terrestrial stream flow gauge exists, or locations without an actual terrestrial flow gauge but where there is specific interest in understanding potential future flow conditions (i.e. a synthetic stream flow gauge). Any number of actual and synthetic flow gauges can be added to the fully integrated hydrologic simulator 216.

The groundwater forecast represents groundwater level (or pressure head) in the fully-integrated hydrologic simulator 216. The groundwater forecast can be visualized as time series data representing conditions at a discrete point in space, or as temporally and spatially varying geospatial data that represents conditions across the entire area for which the fully-integrated hydrologic forecast has been produced. The points can represent locations where either an actual groundwater monitoring location exists, or locations without actual real-world monitoring but where there is specific interest in understanding potential future groundwater conditions (i.e. a synthetic groundwater monitoring point). Any number of actual and synthetic groundwater monitoring points can be added to the fully integrated hydrologic simulator model.

The soil moisture forecast represents soil moisture level in the fully-integrated hydrologic simulator model. The soil moisture forecast can be visualized as time series data representing conditions at a discrete point in space within the soil profile, or as temporally and spatially varying geospatial data that represents conditions within a specific soil layer across the entire area for which the fully-integrated hydrologic forecast has been produced. The points can represent locations where either an actual soil moisture monitoring location exists, or locations without actual real-world monitoring but where there is specific interest in understanding potential future soil moisture conditions (i.e. a synthetic soil moisture monitoring point). Any number of actual and synthetic soil moisture monitoring points can be added to the fully integrated hydrologic simulator model.

While not directly comparable to measured hydrologic indices, the evapotranspiration forecast, as predicted by the fully-integrated hydrologic simulator model 216 (i.e. the amount of water evaporated from the land surface or transpired by plants) is a useful metric for gauging agricultural crop health during the growing season. Accordingly, evapotranspiration output from the simulator can be postprocessed (such as by the data processor 220) and geospatially visualized in temporal increments that span the forecast interval. Evapotranspiration can be visualized as time series data representing conditions at a discrete point in space, or as temporally and spatially varying geospatial data that represents conditions across the entire area for which the fully-integrated hydrologic forecast has been produced.

Snow pack forecast may be a product of the postprocessing of the raw forecast data that is conducted within the forecasting platform. The snowpack forecast can include snow related variables such as snow depth and/or snow water equivalent (SWE) and is cumulative based on near real-time snowpack conditions plus snow accumulation and melt derived from the weather forecast over the forecast time interval. Snow pack data can be visualized as time series data representing conditions at a discrete point in space, or as temporally and spatially varying geospatial data that represents conditions across the entire area for which the fully-integrated hydrologic forecast has been produced. The models that are to be displayed to a user may be seen as the dynamic output 222.

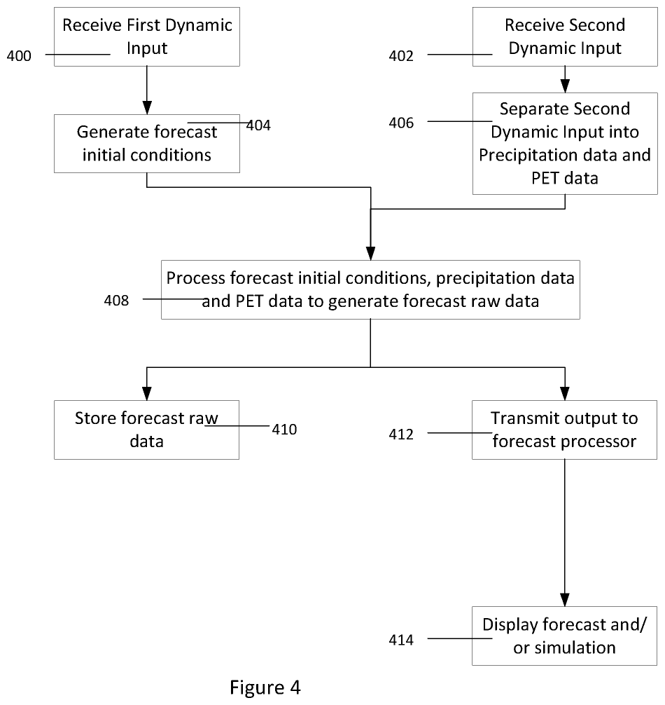

Turning to FIG. 4, a flowchart outlining a method of hydrologic forecasting is shown. Initially, a first dynamic input (400) and a second dynamic input (402) are received by the system. As will be understood, the dynamic inputs may be received independent of each other. The dynamic inputs may be received based on API calls by the system, received based on user input and/or received from external systems pushing the data to the system of the disclosure.

A set of forecast initial conditions are then generated (404). In one embodiment, the first dynamic input is transmitted along with a set of pre-stored model states (such as initial watershed conditions) to an initial condition assimilator. The initial condition assimilator then compares the first dynamic input with pre-stored model states within the model state library to determine a set of real-world states that can be used as forecast initial conditions. This comparison provides a more realistic starting point for the forecast being generated. In one embodiment, the comparison may involve scoring each candidate model state from the pre-stored model state library using a user-defined objective function. With respect to the second dynamic input, this input is separated into precipitation data and PET data (406).

The forecast initial conditions, the precipitation data and the PET data are then processed (408) by the simulation model to create raw forecast data. The raw data, or new model state, is then stored in the model state library (410) so that it may be used or selected in the future for other forecasts and/or simulations.

The forecast raw data can also be transmitted to a forecast data processor (412) for the generation of the forecast and/or simulation model which is then displayed to a user (414). FIG. 3 provides a conceptual depiction of the physical processes that may be represented within a simulation model.

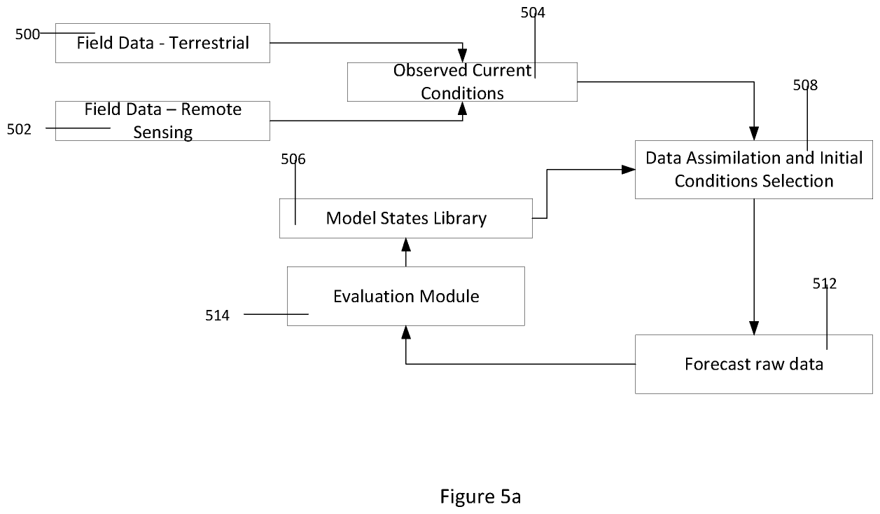

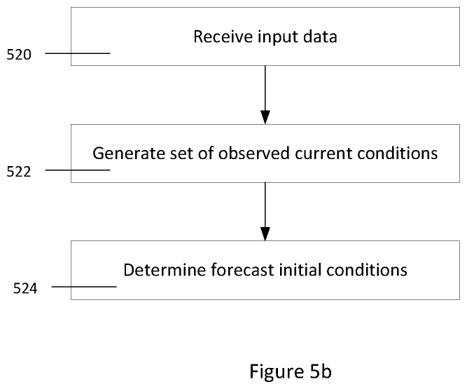

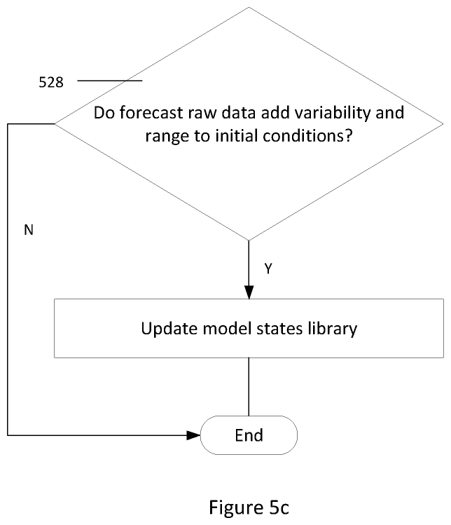

Turning to FIG. 5a, a schematic process diagram of initial condition assimilation is shown. For the initial condition assimilation, terrestrial field data 500 and remote sensing field data 502 may be combined into an observational dataset 504 or set of observed current conditions. The observational dataset represents an estimation or observation of real-world conditions, and may be considered an observation state vector. Examples of terrestrial field data 500 include, but are not limited to, terrestrial sensed groundwater data, terrestrial sensed surface water data, terrestrial sensed soil moisture data and terrestrial sensed snow data. Examples of remote sensing field data include, but are not limited to, remotely sensed groundwater data, remotely sensed surface water data, remotely sensed soil moisture data and remotely sensed snow data. The different types of field data are discussed in more detail below.

The current observational data 504 is combined, or compared, with data stored in a model state library 506 to enable data assimilation and initial condition(s) selection 508. The model state library 506 may provide multiple predetermined numerically stable surface water, groundwater and/or soil moisture conditions to be selected and used by the fully integrated simulator 216. In a preferred embodiment, the model states that best match the current real world state data 504 are selected for use as initial conditions in the forecast and/or simulation to be generated. In another embodiment, the model states may be evaluated against the observational data 504 using a user-defined objective function or loss function and/or a brute force optimization approach.

An output of the data assimilation and initial conditions selection 508 is transmitted as forecast initial conditions for a forecast simulation which generates forecast raw data 512 that is then stored in the model state library 506. Although not necessary in each embodiment, the system may include an evaluation module 514 for evaluating the forecast raw data 512 before it is stored in the model state library 506.

Turning to FIG. 5b, a flowchart outlining a method for determining forecast initial conditions is shown. Initially, input data, such as terrestrial field data and/or remote sensing field data, is received 520. The received input data is then processed and used to generate an observational dataset (or current real-world state sample dataset) 522. The current observational data may be seen as a sample or sub-set of real-time world conditions that can be used to assist in determining initial conditions to be used for the forecast and/or simulation.

After the observational data is generated, the forecast initial conditions for use in the forecast are selected 524. In one embodiment, the system compares the parameters or states from the observational data with the set of model states stored within the model state library to determine which stored model state best matches the observational dataset. The model states that best fit the observational data are then used as the forecast initial conditions.

In one embodiment, candidate model states (associated with previously stored watershed conditions) from the model state library may be compared with watershed conditions within the observational data, which represent an estimate of current watershed conditions. The closest watershed conditions model states to the watershed conditions associated with the real-world observational data are then used or selected as initial watershed conditions for the forecast and/or simulation.

Turning to FIG. 5c, a method of storing raw forecast data is shown. This method is preferably performed after raw forecast data has been generated by the simulator component 216. A check is performed to determine if the raw forecast data adds variability and range 530 to the model states that were used in generating the forecast initial conditions. If it is determined that there is added variability and range, the model state library is updated 532 with relevant information from the raw forecast data in order to maintain a current model state library for use in future forecasts and/or simulations. In this manner, the model state library may be regularly updated with model states that may be more relevant for generating the forecast or model rather than relying on model states that were previously determined or sensed. Alternatively, all raw forecast data is stored in the model state library so that open-loop simulations may be performed without the need for any check on variability or range (or any other criteria).

In another embodiment, the model state library may be regularly evaluated to determine uniqueness of the stored information. If model states are similar, some of them may be deleted. Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

What is claimed is:

1. A method of real-time simulation and forecasting in a fully-integrated hydrologic environment comprising:
receiving a set of input field data;
determining a set of real-world observations based on the set of input field data; and
determining a set of forecast initial conditions based on the set of real-world observations and a library of archived model states.

2. The method of claim 1 wherein determining the set of forecast initial conditions comprises:
comparing the set of real-world observations with the archived model states; and
selecting the model state or model states that best match with the set of real-world observations.

3. The method of claim 2 wherein selecting the model state or model states comprises:
performing an optimization approach on between the archived model states against the real-world observations.

4. The method of claim 3 wherein selecting the model state or model states further comprises:
evaluating the archived model states against the real-world observations using a user-defined objective function or user-defined loss function.

5. The method of claim 1 further comprising:
generating raw forecast data based on the forecast initial conditions.

6. The method of claim 5 further comprising:
storing the raw forecast data in the library of archived model states.

7. The method of claim 5 further comprising:
generating a forecast and/or simulation based on the raw forecast data.

8. The method of claim 7 further comprising:
displaying the forecast and/or simulation.

9. The method of claim 5 further comprising:
comparing the raw forecast data with the selected model states to determine if there is variability and/or range between the raw forecast data and the selected model states; and
updating the library or archived model states to include the raw forecast data if variability and/or range is determined.

10. The method of claim 1 further comprising:
receiving a set of weather forecast data; and
processing the set of forecast initial conditions and the set of weather forecast data to generate the raw forecast data.

11. The method of claim 10 wherein the set of weather forecast data comprises:
a set of precipitation data; and
a set of potential evapotranspiration data.

12. The method of claim 10 further comprising:
generating a forecast and/or simulation based on the raw forecast data.

13. The method of claim 12 further comprising:
displaying the forecast and/or simulation.

14. A system for generating a real-time simulation and forecast in a fully-integrated hydrologic environment comprising:
an initial conditions assimilator for receiving a set of input field data and a set of archived model states and comparing the set of input field data and the set of archived model states to determine which of the set of archived model states best match the set of input field data, wherein the determined set of archived model states represents forecast initial conditions; and
a simulation component for generating raw forecast data based on the forecast initial conditions and a set of weather input data.

15. The system of claim 14 further comprising:
a weather processing component for separating the set of weather input data into precipitation data and potential evapotranspiration.

16. The system of claim 14 further comprising:
a database storing the set of archived model states.

17. A computer readable medium having stored thereon instructions that, when executed, cause a processor to:
receive a set of input field data;
determine a set of real-world observations based on the set of input field data; and
determine a set of forecast initial conditions based on the set of real-world observations and a library of archived model states.
